(19) United States
(12) Patent Application Publication
(10) Pub. No.: US 2018/0029218 A1
(43) Pub. Date: Feb. 1, 2018

(54) FOLD-AWAY WALL-MOUNTED SUPPORT

(71) Applicant: CIE EUROPE, LOMME (FR)

(72) Inventor: Giulio EPICUREO, LILLE (FR)

(21) Appl. No.: 15/550,381

(22) PCT Filed: Feb. 12, 2016
(86) PCT No.: PCT/FR2016/050324

§ 371 Date: Aug. 11, 2017

(30) Foreign Application Priority Data
Feb. 12, 2015 (FR) 15 51134

(51) Int. Cl. B25H 3/04; B62H 3/12

(52) U.S. Cl. CPC B25H 3/04; B62H 3/12

(57) ABSTRACT

The invention relates to a foldaway wall mount (10) comprising:
a support arm (12) having a first end portion (18); and
a base (14) having a fastener portion (40) for fastening the base (14) to the wall (M), and a reception portion (42) defining a housing having a longitudinal axis (B) for removably receiving the first end portion (18) of the support arm (12), the support arm (12) presenting either a first position or a second position that is pivoted relative to the first position, and the first end portion (18) and the reception portion (42) include blocking means for blocking pivoting of the support arm (12) relative to the base (14) when the support arm is in at least one of the first and second positions.

### BACKGROUND

The disclosure relates to the field of wall mounts, as are to be found in particular in garages, and that serve to support objects, such as for example gardening accessories, a ladder, or indeed a bicycle.

Known wall mounts include storage hooks that are fastened to the wall of the garage and that enable various objects to be attached.

Such storage hooks are generally screwed to the wall so as to extend perpendicularly from the surface of the wall.

A drawback of such hooks is that they occupy a particularly large amount of space when they remain attached to the wall, but without being used. Very often, storage hooks that are not used during a determined period, e.g. during a season, are not taken down and are found to get in the way, in particular when the storage hook is fastened to the wall of a garage of small area.

### DISCLOSURE SUMMARY

An object of the disclosure is to provide a wall mount that remedies the above-mentioned drawbacks.

For this purpose, the disclosure provides a foldaway wall mount for fastening to a wall, said mount comprising:
a support arm having a first end portion; and
a base having a fastener portion for fastening the base to the wall, and a reception portion defining a housing having a longitudinal axis for removably receiving the first end portion of the support arm, the reception portion and the first portion being arranged in such a manner that the support arm presents either a first position or a second position that is pivoted relative to the first position, and in which the first end portion and the reception portion include blocking means for blocking pivoting of the support arm relative to the base about the longitudinal axis when the support arm is in at least one of the first and second positions.

It can be understood that the base is for fastening securely to the wall, while the support arm can be uncoupled from the base, e.g. in order to be put away while it is not in use. In addition, the support arm of the wall mount of the disclosure is advantageously suitable for folding away.

The support arm may be moved away from the first position, its utilization position in which it performs its mounting function, to a pivoted second position, i.e. its position folded away against the wall. In other words, when it is desired to use the wall mount for attaching an article, the support arm is put into its first position in which the support arm extends transversely relative to the surface of the wall. Conversely, when the wall mount of the disclosure is not in use, the support arm is moved into its second position, in which it is folded away against the wall, thereby substantially reducing the space occupied by the mount.

In the disclosure, the blocking means serve to block the support arm against pivoting relative to the base whenever the support arm is in at least one of the first and second positions, in order to prevent the support arm from changing position in unwanted manner. The support arm is then prevented from pivoting in at least one of the two positions.

The blocking means may enable the support arm to be prevented from pivoting relative to the base when the support arm is in the first position and when it is in the second position.

The blocking means may be arranged to block the support arm from pivoting relative to the base when the support arm is in its first position or in its second position. Consequently, the support arm is not free to pass from its first position to its second position, or vice versa, thereby providing the wall mount of the disclosure with additional safety.

In order to change the position of the support arm, the user can uncouple the support arm by extracting it from the base, causing it to pivot about a pivot axis parallel to the longitudinal axis, and then engage it once more in the reception portion.

In order to change the position of the support arm, it may be raised a little by moving in translation along the longitudinal axis, while remaining engaged in the reception portion, after which it is pivoted about the longitudinal axis, and then lowered again. It can be understood that the blocking means are configured to act when the first end portion is fully engaged in the reception portion, and that they leave the support arm free to pivot relative to the base when the arm is lifted a little.

Advantageously, the reception portion of the base comprises a tube in which the first end portion of the support arm is slidably mounted. The support arm can then easily be uncoupled from the base by lifting the support arm in order to disengage it from the base. As mentioned above, the first end portion can also be lifted a little, while remaining partially engaged in the reception portion, so as to facilitate passing from one position to the other.

In order to do this, the first end portion of the support arm is pivotally mounted in the tube. The cross-sections of the reception portion and of the end portion may both be circular.

In a particularly advantageous aspect of the disclosure, the blocking means comprise a retaining element arranged at the bottom end of the tube while extending transversely inside the tube, and at least one cavity arranged in the first end portion of the support arm for the purpose of receiving the retaining element when the first end portion of the support arm is engaged in the tube so as to prevent the support arm from pivoting relative to the base.

It can thus be understood that when the end portion is engaged in the tube and said at least one cavity is co-operating with the retaining element, pivoting of the support arm about the longitudinal axis is prevented. When the support arm is lifted a little, the retaining element is no longer coupled with the cavity, thus leaving the support arm free to pivot in the tube about the longitudinal axis, thereby enabling the user to change the position of the support arm.

The first end portion may have a first pair of diametrically opposite cavities, with the retaining element being received in the cavities of the first pair so as to hold the support arm in the first position.

The first end portion may comprise a cylindrical skirt with the cavities of the first pair being formed at its bottom end.

The first end portion may include at least one second pair of diametrically opposite cavities, the second pair of cavities being arranged orthogonally relative to the first pair of cavities, the retaining element being received in the cavities of the second pair in order to hold the support arm in the second position.

The transverse dimension of the retaining element may be substantially equal to or slightly smaller than the width of the cavities, so as to block pivoting about the longitudinal axis of the tube. It can be understood that the side edges of the cavities form abutments for the retaining element, thus preventing the support arm from pivoting relative to the tube. Without going beyond the ambit of the present disclosure, a small amount of clearance may exist between the retaining element and the edges of the cavities.

The cavities may be notches arranged in a bottom peripheral wall of the first end portion. The notches may extend in the axial direction of the tube.

The blocking means may also constitute retaining means for holding the support arm axially in the base. For this purpose, the retaining element also constitutes an axial abutment for holding the first end portion in the tube. It can thus be understood that the retaining element constitutes both means for blocking pivoting so as to hold the support arm in its first position or its second position, and also an axial abutment element serving to carry the support arm.

When the retaining element is engaged in the cavities, the retaining element being under the cavities, the ends of the cavities may come axially into contact with the rod, thereby causing the first end portion and thus the support arm to be carried by the retaining element.

The retaining element may be a rod that extends diametrically inside the tube at its bottom end. The rod may be fastened to the tube, which itself is fastened to the fastener portion.

As mentioned above, the cross-sections of the base tube and of the first end portion of the support arm are both circular, for the purpose of enabling the support arm to pivot relative to the base. Furthermore, the outside diameter of the first end portion is substantially equal to or slightly less than the inside diameter of the tube.

The fastener portion may include a trough receiving the tube, and two attachment orifices arranged beyond the ends in the height direction of the tube. The tube may be welded to the fastener portion, and the attachment orifices serve to receive fastener screws for fastening to the wall.

The support arm may include at least one support portion that extends orthogonally relative to the first end portion.

In a variant, the support arm forms a storage hook.

The disclosure also provides an installation kit comprising a wall mount of the present disclosure and verification means configured to be fastened to the base in order to make it possible to verify that the longitudinal axis extends in a substantially vertical direction during the mounting step.

Finally, the disclosure provides a method of mounting on a wall a mount having a fastener portion that includes first and second attachment orifices, the method comprising the following steps:
fastening the first attachment orifice of the fastener portion on the wall;
pivoting the base in the plane of the wall about a first axis passing through the first attachment orifice so that the longitudinal axis extends in a direction that is substantially vertical; and
fastening the second attachment orifice of the fastener portion to the wall.

### BRIEF DESCRIPTION OF THE DRAWINGS

The disclosure can be better understood on reading the following description of an embodiment of the disclosure given by way of non-limiting example and with reference to the accompanying drawings, in which:

FIG. 1 is a perspective view of a wall mount of the disclosure, the support arm being shown decoupled from its base;

FIG. 2 shows the support arm of the FIG. 1 wall mount;

FIG. 3 is a view from beneath of the base of the FIG. 1 wall mount;

FIG. 4 is a perspective view of the FIG. 1 wall mount, the support arm being coupled to the base, and being shown in its first position, its in-use position;

FIG. 5A is a section view of the FIG. 4 wall mount, the support arm being blocked against pivoting while in its first position;

FIG. 5B shows the bottom end of the first end portion when the support arm has been lifted so that the retaining element is disengaged from the cavities;

FIG. 6 is a perspective view of the FIG. 2 wall mount, the support being shown in its second position, its folded-away position; and

FIGS. 7A, 7B, and 7C are diagrams showing the various steps of the method of fastening a particular example of a foldaway wall mount of the present disclosure.

### DETAILED DESCRIPTION

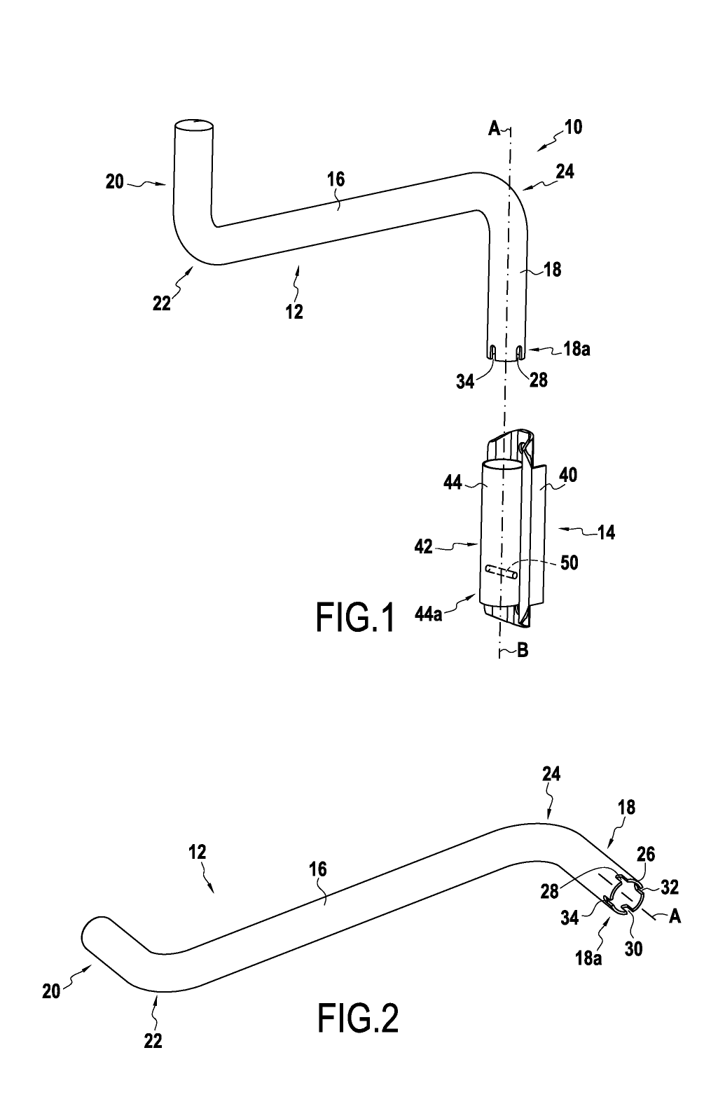

With reference to FIGS. 1 to 6, there follows a description of an embodiment of a foldaway wall mount 10 in accordance with the present disclosure.

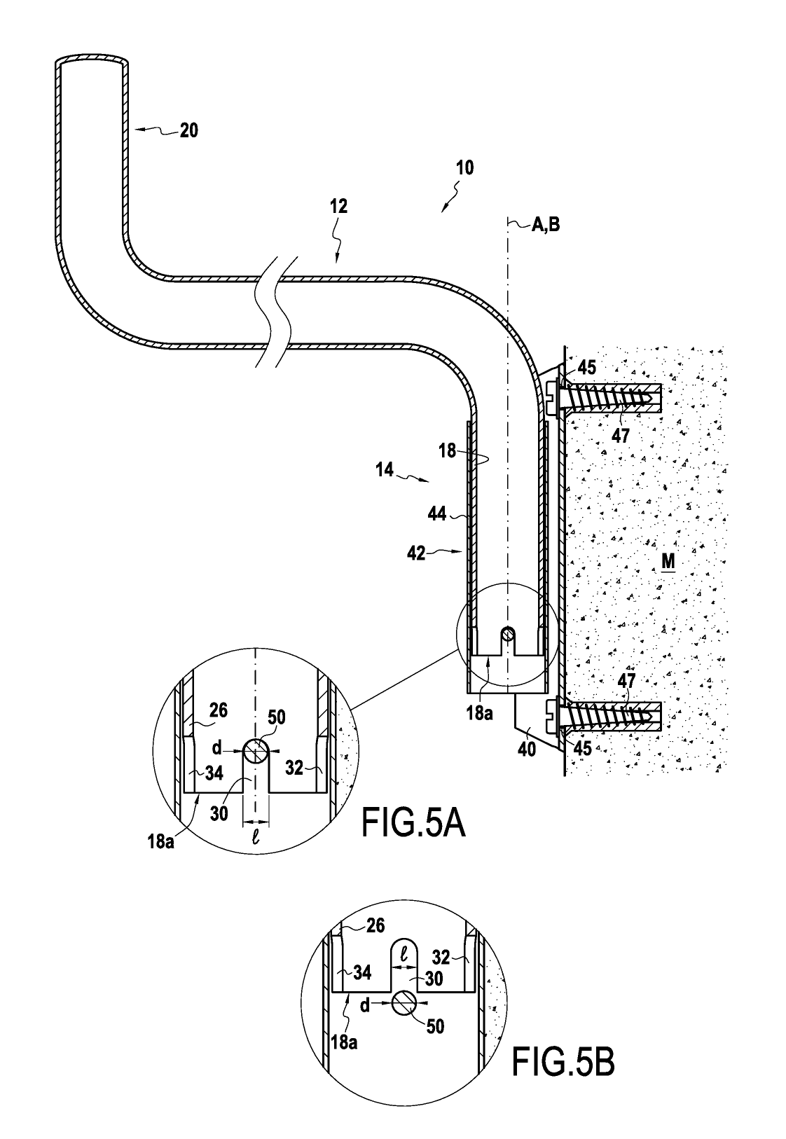

As can be understood from FIG. 5, the foldable mount is for fastening to a wall M. In the meaning of the present disclosure, the term “wall” covers any wall surface, whether indoors or outdoors, and including partitions.

The foldaway wall mount 10 comprises a support arm 12 and a base 14.

In this example, the support arm 12 has a rectilinear support portion 16 arranged between a first end portion 18 and a second end portion 20. The support portion 16 and the second end portion 20 are shaped so as to form a hook. In this example, the second end portion 20 is connected to the support portion 16 via a first bend portion 22, such that the second end portion 20 is substantially orthogonal to the support portion 16.

Likewise, the first end portion 18 is connected to the support portion 16 via a second bend portion 24, so that the support portion 16 extends orthogonally relative to the first end portion 18.

The first end portion 18 has a bottom end 18a that is remote from the second bend portion 24.

This particular shape for the support arm 12 is not limiting on the disclosure, other shapes could be envisaged as a function of the nature and the shape of the objects to be supported.

As can be understood from FIG. 2, in this example, the first end portion 18 is tubular in shape of cross-section that is circular.

More precisely, the bottom end 18a of the end portion 18 has a peripheral wall 26 with a first pair of cavities 28, 30 formed therein, which cavities are in the form of notches, and with a second pair of cavities 32 and 34 that are also formed therein, which cavities are likewise in the form of notches.

The cavities 28, 30, 32, 34 of the first and second pairs thus form notches that, in this example, extend in the longitudinal direction A of the first end portion 18. In this example, the axial extent of the notches is about 1 centimeter (cm).

Furthermore, the cavities 28, 30 of the first pair are diametrically opposite. The same is true of the cavities 32, 34 of the second pair.

In addition, the first and second pairs of cavities are mutually orthogonal when considered in a plane perpendicular to the longitudinal axis A.

The function of these cavities is described below.

With reference once more to FIG. 1, it can be seen that the base 14 of the foldaway wall mount 10 has a fastener portion 40 for fastening the base 14 to the wall M. The base 14 also has a reception portion 42 that, in this example, comprises a tube 44 defining a housing of longitudinal axis B. The tube 44 is welded to the fastener portion.

The fastener portion 40 has a trough 43 receiving the tube 44. It also has first and second attachment orifices 45 that lie beyond opposite ends in the height direction of the tube 44, e.g. respectively in the top and bottom portions of the fastener portion 40.

The attachment orifices are for receiving first and second fastener screws 47 for enabling the base 14 to be fastened to the wall M.

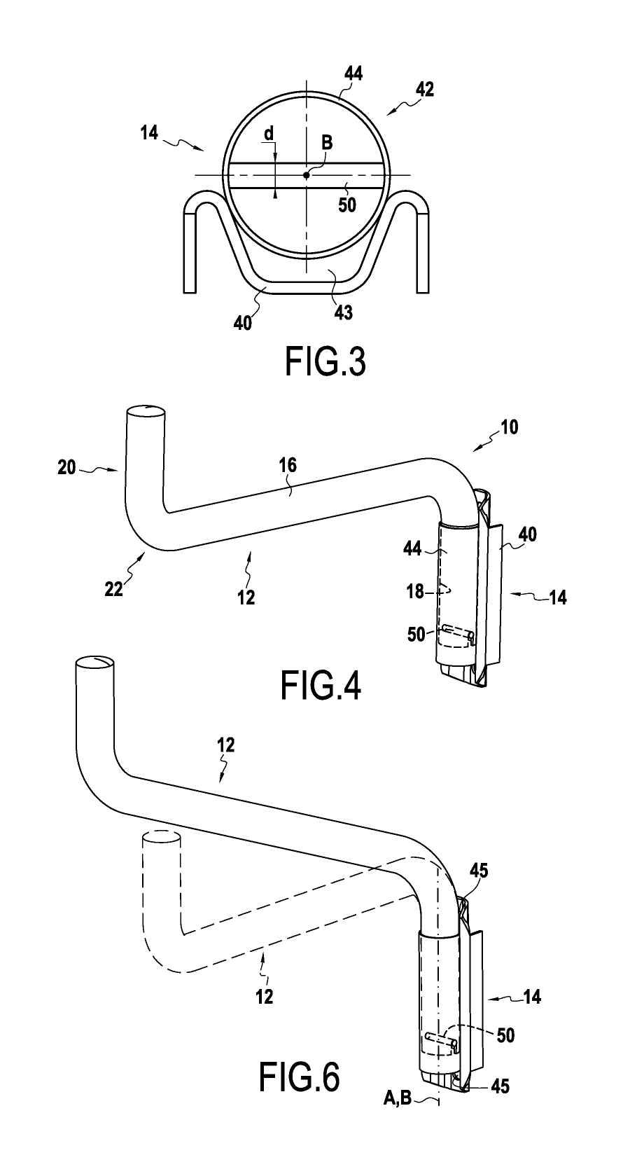

As can be seen in FIG. 3, the cross-section of the tube 44 is circular in shape, with the outside diameter of the first end portion 18 being very slightly smaller than the inside diameter of the tube 44.

The reception portion 42 also includes a retaining element 50 that is arranged at the bottom end 44a of the tube 44. In this example, the retaining element 50 is fastened to the tube and is in the form of a rod that extends transversely inside the tube 44. As can be seen in FIG. 3, the retaining element 50 extends in a diametrical direction of the tube 44. In this example, the retaining element 50 is arranged to extend parallel to the wall. It would not go beyond the ambit of the disclosure for the retaining element 50 to have a position at 90° relative to the example shown in FIG. 3, while continuing to be arranged diametrically.

With reference to FIGS. 1 to 4, it can be understood that the tube 44 is configured to receive removably the first end portion 18 of the support arm 12. More precisely, the first end portion 18 of the support arm 12 is slidably mounted in the tube 44 to slide along the longitudinal axis B of the tube 44. In this example, the bottom end of the first end portion is inserted into the tube via its top end.

Furthermore, insofar as the cross-sections of the first end portion 18 and of the tube 44 are both circular, the outside diameter of the first end portion being substantially equal to or slightly less than the inside diameter of the tube 44, it can be understood that the first end portion of the arm is also pivotally mounted in the tube 44 to pivot about the longitudinal axis B of said tube, which is substantially vertical in this example.

With reference now to FIGS. 4 and 6, it can be seen that the reception portion 40, and in particular the tube 44 and the first end portion 18 are arranged in such a manner that the support arm 12 can occupy either a first position, i.e. a working position shown in FIG. 4, or a second position, i.e. a folded-away position, as shown in FIG. 6, which position is pivoted relative to the first position.

In FIG. 6, continuous lines show the support arm 12 in its second position, and dashed lines show the same support arm 12 in its first position. In this example, it can be understood that the first and second positions form an angle of about 90° in a plane perpendicular to the longitudinal axis B of the tube 44.

In accordance with the disclosure, the first end portion 18 and the reception portion 42, typically the tube 44, include blocking means for blocking pivoting of the support arm 12 relative to the base 14 about the longitudinal axis B of the tube 44 whenever the support arm is in its first position or its second position.

For this purpose, the blocking means comprise the retaining element 50 and the first and second pairs of cavities 28, 30, 32, 34.

With reference to FIG. 5, it can be understood that when the first end 18 of the support arm 12 is engaged in the tube 44, the longitudinal axes A and B respectively of the first end portion 18 and of the tube 44 coincide and extend in a vertical direction. Under the action of its own weight, the support arm moves downwards such that when the support arm is in one or other of the first and second positions, the first or second pair of cavities engages the retaining element 50.

In the example of FIG. 5A, the support arm is in its first position, and the retaining element 50 is received in the cavities 28 and 30 of the first pair of cavities.

It can also be seen in FIG. 5A that the retaining element 50 presents a diameter d that is substantially equal to the width l of the cavities, such that co-operation between the retaining element 50 and the pair of cavities 28 and 30 has the effect of preventing the support arm from pivoting about the longitudinal axis B of the tube 44.

Still with reference to FIG. 5A, it can also be seen that the retaining element 50 is engaged fully in the notches 28 and 30, whereby the end portion 18 stands on the retaining element 50. Thus, the retaining element 50 also constitutes an axial abutment for holding the first end portion 18 in the tube 44.

The retaining element 50 thus advantageously presents two functions, both of serving to prevent the support arm 12 from pivoting relative to the base 14 also and of carrying the support arm 12.

With reference to FIGS. 5A, 5B, and 6, it can be understood that it is possible to go from the first position to the second position by raising the support arm 12 a little so that the retaining element 50 leaves the cavities 28 and 30, after which the user can turn the support arm 12 in the tube 44 about the longitudinal axis B of the tube 44. Thereafter, in order to block the support arm 12 in its second position, the support arm is lowered so that the first end 18 slides downwards in the tube 44 until the cavities 32 and 34 of the second pair engage the retaining element 50, thereby preventing the support arm 12 from pivoting in the base 14 and also holding it.

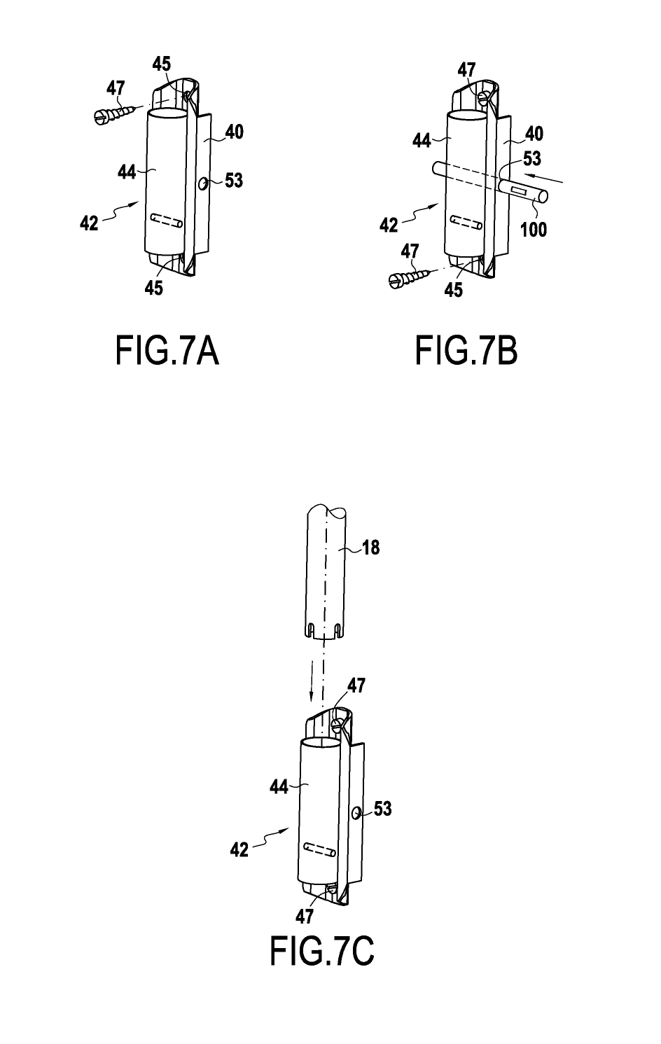

FIGS. 7A, 7B, and 7C are diagrams showing the various steps of the method of mounting the foldaway wall mount 10 on the wall M.

The first attachment orifice 45 of the fastener portion 40 is initially fastened to the wall M by means of the first fastener screw 47.

Thereafter, verification means 100 are fastened to the fastener portion 40, e.g. in removable manner. The disclosure thus also relates to an installation kit comprising the foldaway wall mount 10 and the verification means 100.

By way of example and in non-limiting manner, the fastener portion 40 includes a mounting orifice 53 configured to enable the verification means 100 to be mounted. Without going beyond the ambit of the present disclosure, it would naturally be possible to devise a base 14 including any other fastener means configured to enable the verification means 100 to be fastened thereto, e.g. in removable manner; for example, it would be possible to devise fastener means including a magnetic or a metal portion, with the verification means 100 correspondingly including a metal or a magnetic portion.

In this example, the verification means 100 are configured to be fastened to the fastener portion; they could equally well be fastened to the reception portion.

Thereafter, the base 14 is pivoted in the plane of the wall M about the first fastener screw 47 so that the longitudinal axis B extends in a direction that is substantially vertical.

By way of example and in non-limiting manner, the verification means 100 comprise a spirit level, with the verification means 100 thus being configured to make it possible to verify that the longitudinal axis B does indeed extend in a substantially vertical direction, after being pivoted about the first fastener screw 47 in the plane of the wall M.

Thereafter, and as shown in FIG. 7B, the second attachment orifice 45 of the fastener portion 40 of the base 14 is fastened to the wall M by means of the second fastener screw 47.

As shown in FIG. 7C, the base 14 is then fastened to the wall M in such a manner as to receive the first end portion 18 of the support arm 12.

1. A foldaway support mount for fastening to a wall, said mount comprising:
a support arm having a first end portion; and
a base having a fastener portion for fastening the base to the wall, and a reception portion defining a housing having a longitudinal axis for removably receiving the first end portion of the support arm, the reception portion and the first end portion being arranged in such a manner that the support arm presents either a first position or a second position that is pivoted relative to the first position, and in which the first end portion and the reception portion include a blocking device for blocking pivoting of the support arm relative to the base about the longitudinal axis when the support arm is in at least one of the first and second positions.

2. The mount according to claim 1, wherein the reception portion of the base comprises a tube in which the first end portion of the support arm is slidably mounted.

3. The mount according to claim 2, wherein the first end portion of the support arm is pivotally mounted in the tube.

4. The mount according to claim 2, wherein the blocking device comprise a retaining element arranged at the bottom end of the tube while extending transversely inside the tube, and at least one cavity arranged in the first end portion of the support arm for the purpose of receiving the retaining element when the first end portion of the support arm is engaged in the tube so as to prevent the support arm from pivoting relative to the base.

5. The mount according to claim 4, wherein the first end portion has a first pair of diametrically opposite cavities, with the retaining element being received in the cavities of the first pair so as to hold the support arm in the first position.

6. The mount according to claim 5, wherein the first end portion includes at least one second pair of diametrically opposite cavities, the second pair of cavities being arranged orthogonally relative to the first pair of cavities, the retaining element in the cavities of the second pair in order to hold the support arm in the second position.

7. The mount according to claim 4, wherein the cavities are notches arranged in a bottom peripheral wall of the first end portion.

8. The mount according to claim 4, wherein the retaining element also constitutes an axial abutment for holding the first end portion in the tube.

9. The mount according to claim 2, wherein the cross-sections of the tube of the base and of the first end portion of the support arm are circular.

10. The mount according to claim 2, wherein the fastener portion includes a trough receiving the tube, and first and second attachment orifices arranged beyond the ends in the height direction of the tube.

11. The mount according to claim 1, wherein the support arm includes at least one support portion that extends orthogonally relative to the first end portion.

12. An installation kit comprising:
a wall mount according to claim 1; and
a verification device configured to be fastened to the base in order to make it possible to verify that the longitudinal axis extends in a substantially vertical direction during the mounting step.

13. A method of mounting a mount according to claim 10 on a wall, comprising the following steps:
fastening the first attachment orifice of the fastener portion on the wall;
pivoting the base in the plane of the wall about a first axis passing through the first attachment orifice so that the longitudinal axis extends in a direction that is substantially vertical; and
fastening the second attachment orifice of the fastener portion to the wall.
